(19) United States
(12) Patent Application Publication
(10) Pub. No.: US 2014/0020079 A1
(43) Pub. Date: Jan. 16, 2014

(54) METHOD FOR PROVIDING NETWORK SERVICE AND APPARATUS THEREOF

(71) Applicant: Tencent Technology (Shenzhen) Company Limited, Shenzhen City (CN)

(72) Inventor: Zhaohua Lu, Shenzhen (CN)

(73) Assignee: Tencent Technology (Shenzhen) Company Limited, Shenzhen City (CN)

(21) Appl. No.: 14/036,932

(22) Filed: Sep. 25, 2013

Related U.S. Application Data
(63) Continuation of application No. PCT/CN2012/084906, filed on Nov. 20, 2012.

(30) Foreign Application Priority Data
Nov. 22, 2011 (CN) 201110373463.9

(51) Int. Cl. H04L 29/06

(52) U.S. Cl. CPC H04L 63/0815
USPC 726/8

(57) ABSTRACT

A method for providing network service and apparatus thereof are described. The method includes the following steps: acquiring a network identity information of a user wherein the network identity information stored in a browser is a kind of information with an unique recognition; matching the network identity information with a local identity database to determine whether the local identity database stores a binding relationship between the network identity information and a server account information of the user; querying the server account information stored in the local identity database based on the network identity information of the binding relationship if the network identity information is matched with the local identity database to be found in the local identity database; and automatically logging in the web server based on the server account information of the user.

### CROSS REFERENCE TO RELATED APPLICATION

This application is a continuation of International Application No. PCT/CN2012/084906, filed on Nov. 20, 2012, which claims priority to Chinese patent application No. 201110373463.9, filed on Nov. 22, 2011, the content of which are incorporated herein by reference in their entirety.

### FIELD OF THE INVENTION

The present invention relates to an Internet network application, and more particularly to a method for providing network service and apparatus thereof.

### BACKGROUND OF THE INVENTION

In the modern society, the web server provides the users with the information including a variety of figures, texts, data and contents for the purpose of the browse behavior so that the network application is an indispensable service field of the knowledge acquirement and information exchange for the users.

While the user utilizes a browser application program to browse the network content via Internet, the user is usually required to login the web server. In fact, because the user must manually login the web server in each visit, it is quite a minute and complicated task. A conventional method of logging in the web server includes the following steps: (1) collecting the account information of the user by the web server; (2) verifying the validity of the account information; (3) successfully logging in the web server if the account information is valid; and (4) storing the account information of the user into the browser by the web server in a short time interval. Specifically, the account information is temporarily stored in the “Cookie” file (i.e. little volume of information) of the browser so that the user can log in the web server during the short time interval.

The conventional method of logging in the web server includes the following drawbacks: (1) the user employs the conventional method to automatically and effectively log in the web server during only a short time interval but not a limitless time interval by using the account information; and (2) if the user visits many web servers during a predetermined time, it is required that the user registers an account and password in each of the web servers, and if each of accounts is different, the user hardly memorizes the account information since the corresponding relationships between the accounts, passwords and the web servers are very complicated.

### SUMMARY OF THE INVENTION

One objective of the present invention is to provide a method for providing network service and apparatus thereof to solve the problem of hardly memorizing the account information since the corresponding relationships between the accounts, passwords and the web servers are very complicated.

According to the above objective, the present invention sets forth a method for providing network service and apparatus thereof.

In the first embodiment, the present invention provides a method for providing a network service, the method comprising the steps of:

collecting a browser account information of a user by a browser;

encrypting the browser account information of the user by the browser for generating a network identity information with an unique recognition and storing the network identity information in the browser;

acquiring the network identity information of the user from the browser by a web server;

matching the network identity information with a local identity database by the web server to determine whether the local identity database stores a binding relationship between the network identity information and a server account information of the user of the web server;

querying the server account information stored in the local identity database by the web server based on the network identity information of the binding relationship if the network identity information is matched with the local identity database to be found in the local identity database;

requesting the user to either register or login the web server if the network identity information is not found in the local identity database, and mapping the server account information of the user to the network identity information for storing the mapping result in the local identity database after the user responds to the request of the web server; and

automatically logging in the web server based on the server account information of the user.

In the second embodiment, the present invention provides a method for providing a network service, the method comprising the steps of:

acquiring a network identity information of a user wherein the network identity information with an unique recognition is stored in a browser;

matching the network identity information with a local identity database to determine whether the local identity database stores a binding relationship between the network identity information and an account information of the user;

querying the account information stored in the local identity database based on the network identity information of the binding relationship if the network identity information is matched with the local identity database to be found in the local identity database; and

automatically logging in the web server based on the account information of the user.

In the third embodiment, the present invention provides an apparatus for providing a network service applicable to a browser and a web server, the apparatus comprising:

a browser login module, for collecting a browser account information of a user;

an identity information generation module, for encrypting the browser account information of the user for generating a network identity information with an unique recognition and storing the network identity information in the browser;

an identity information acquisition module, for acquiring the network identity information of the user;

a local identity database, for storing a binding relationship between the network identity information and a server account information of the user of the web server;

an identity information matching module, for matching the network identity information from the identity information acquisition module with the local identity database;

an account information querying module, for querying the server account information stored in the local identity database based on the network identity information of the identity information acquisition module if the identity information matching module matches the network identity information with the local identity database to be found in the local identity database; and

an automatic login module, for automatically logging in the web server based on the server account information of the user.

In the fourth embodiment, the present invention provides a web server, comprising:

an identity information acquisition module, for acquiring a network identity information of a user wherein the network identity information with an unique recognition is stored in a browser;

a local identity database, for storing a binding relationship between the network identity information and an account information of the user of the web server;

an identity information matching module, for matching the network identity information from the identity information acquisition module with the local identity database;

an account information querying module, for querying the account information which is stored in the local identity database based on the network identity information of the identity information acquisition module if the identity information matching module matches the network identity information with the local identity database to be found in the local identity database; and

an automatic login module, for automatically logging in the web server based on the account information of the user.

In the fifth embodiment, the present invention provides a browser, comprising:

a browser-registering module, for collecting a browser account information of a user; and

an identity information generation module, for encrypting the browser account information of the user for generating a network identity information with an unique recognition and storing the network identity information in the browser.

According to the above-mentioned descriptions, the apparatus for providing a network service in the fourth embodiment stores the network identity information of the user in the browser beforehand so that the web server maps the network identity information stored in the browser to the account information of the local identity database. Then, when the web server receives the network identity information from the browser again, the web server performs automatic login procedure. On one hand, the network identity information is continuously retained in the browser so that the web server performs automatic login procedure all the time, i.e. in a limitless time interval. On the other hand, if the user stores the network identity information in the browser and initially registers or login the web server when the user first visits the web servers, each of the web servers can perform automatic login procedures to prevent the user from memorizing the account information corresponding to a variety of web servers for increasing the user experience. The method of the present invention is used to register one account in each of web servers and perform automatic login procedure in each of web servers by using the browser.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart of a method for providing network service according to the first embodiment of the present invention;

FIG. 2 is a flow chart of a method for providing network service according to the second embodiment of the present invention;

FIG. 3 is a flow chart of a method for providing network service according to the third embodiment of the present invention;

FIG. 4 is a schematic block diagram of an apparatus for providing network service according to the fourth embodiment of the present invention; and

FIG. 5 is a schematically structural block diagram of an identity information acquisition module according to the fourth embodiment of the present invention.

### DETAILED DESCRIPTION OF THE PREFERRED EMBODIMENTS

### First Embodiment

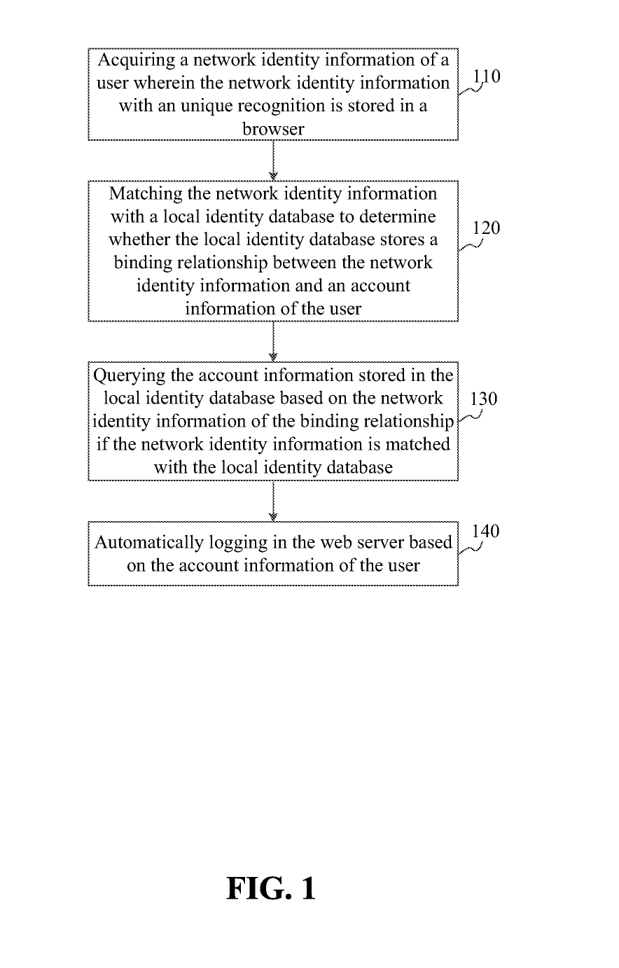

Please refer to FIG. 1. FIG. 1 is a flow chart of a method for providing a network service according to the first embodiment of the present invention. The method for providing a network service is applicable to a web server and the method includes the following steps.

In step 110, a network identity information of a user is acquired wherein the network identity information stored in a browser is the information with an unique recognition.

The user stores the network identity information with a unique recognition in the browser beforehand. When the user visits a web server, the web server issues a read request for reading the network identity information of the user in the browser. After the browser receives the read request, the browser transmits the network identity information to the web server so that the web server obtains the network identity information.

In step 120, the acquired network identity information is matched with a local identity database to determine whether the local identity database stores a binding relationship between the acquired network identity information and the account information of the user.

The local identity database is disposed in the web server for storing the binding relationship between the network identity information and the account information of the users. In one embodiment, the server account information of the users includes account name and password thereof in the web server. In the beginning, the local identity database is initially empty and however, the binding relationships between the acquired network identity information and the account information of the user are increasingly accumulated while the different users continuously visit the web server. In one case, if the local identity database accumulates some network identity information and the account information mapping to the network identity information, the web server determines whether the acquired network identity information is found in can be found in the local identity database when the web server receives the acquired network identity information. That is, the web server checks whether the acquired network identity information is matched with the information in the local identity database.

In step 130, if the binding relationship exists in the local identity database, the web server queries the server account information stored in the local identity database based on the network identity information of the existing binding relationship.

When the web server successfully assures that the network identity information is matched with the local identity database to be found in the local identity database, the web server is able to query the account information corresponding to the acquired network identity information in the local identity database wherein the account information in the local identity database is mapped to the acquired network identity information.

In step 140, the web server automatically login based on the server account information of the user. After querying the account information corresponding to the acquired network identity information, the web server is capable of performing automatic login procedure since the account information originally belongs to the web server. It should be noted that the automatic login procedure in the web server is well-known in the art after querying the account information. In one embodiment, the server account information includes account name and password thereof for the web server.

According to the above-mentioned descriptions, the method for providing a network service has many advantages. First, the web server maps the network identity information stored in the browser to the account information of the local identity database. Then, when the web server receives the network identity information from the browser again, the web server performs automatic login procedure. On one hand, the network identity information is continuously retained in the browser so that the web server performs automatic login procedure all the time, i.e. in a limitless time interval. On the other hand, if the user stores the network identity information in the browser and initially registers or login the web server when the user first visits the web servers, each of the web servers can perform automatic login procedures to prevent the user from memorizing the account information corresponding to a variety of web servers for increasing the user experience. The method of the present invention is used to register one account in each of web servers and perform automatic login procedure in each of web servers by using the browser.

### Second Embodiment

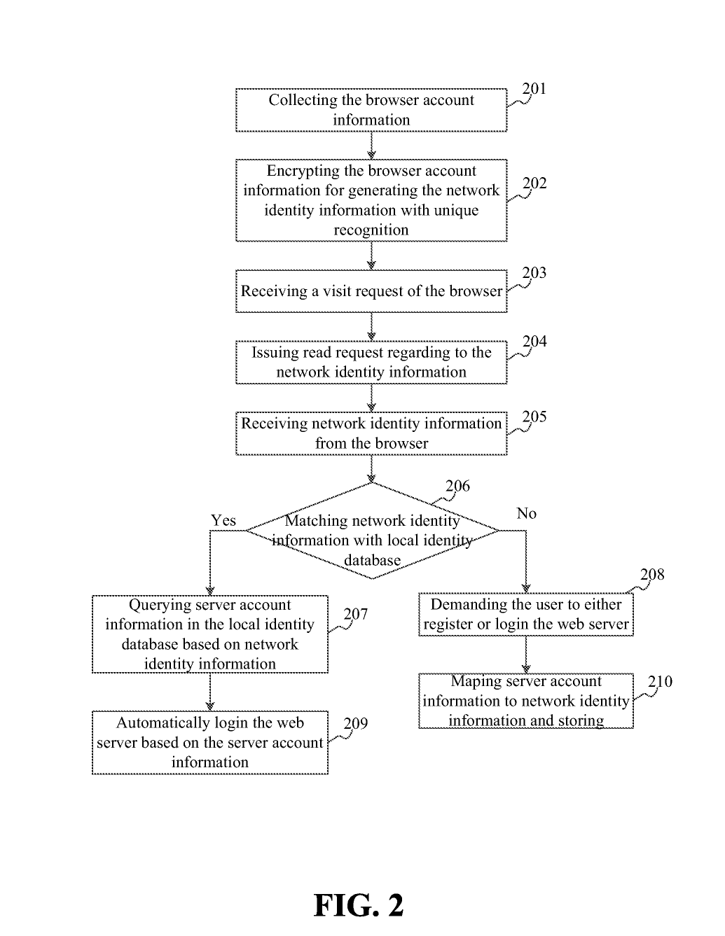

Please refer to FIG. 2. FIG. 2 is a flow chart of a method for providing network service according to the second embodiment of the present invention. The method for providing a network service is applicable to a browser and a web server. The method includes the following steps.

In step 201, a browser collects the browser account information which is registered in the browser by a user.

The browser provides the user with a browser account service so that if the user uses the browser account service, the browser creates a browser account and password thereof for the user. In one embodiment, if the user performs “QQ” browser produced by TENCENT TECHNOLOGY COMPANY LIMITED, the user can register a “QQ” account to be served as the browser account information. If the user has an existing “QQ” account, the user may login the “QQ” browser with the existing “QQ” account.

In step 202, the browser encrypts the browser account information of the user for generating the network identity information which is a unique recognition and the browser stores the network identity information in the browser.

The browser encrypts the browser account information of the user for generating the network identity information which is a unique recognition. In one embodiment, since each of the browser accounts of the users is unique but each of the corresponding passwords of the browser accounts may be the same and therefore, the browser encrypts each of the browser accounts as a unique recognition respectively. For example, the user irreversibly encrypts the browser account as a numeral with 128 bit-length and the browser regards the numeral as the network identity information. In this case, the encryption of the browser account is for the security of the browser account information. However, in another case, if the security between the browser and the web server can be ensured, the browser account is directly regarded as the network identity information.

It should be noted that the browser encrypts the browser account information for generating the network identity information by different encryption algorithm standards, such as Data Encryption Standard (DES), Triple DES (3DES), International Data Encryption Algorithm (IDEA), Digital Signature Algorithm (DSA) and Advanced Encryption Standard (AES).

The web server acquires the network identity information of the user from the browser, including the steps 203 through step 205 as follows.

In step 203, the web server receives a visit request of the browser.

When the user employs the browser to visit the web servers, the browser issues one or more visit requests to the web servers respectively, and the visited web servers receive the visit requests correspondingly if the user desires to enter the web servers.

In step 204, the web server issues a read request regarding to the network identity information based on the visit request of the browser.

After receiving the visit request from the browser, the web server transmits the read request regarding to the network identity information.

In step 205, the web server receives the network identity information which feedbacks from the browser after the browser responds to the read request of the network identity information.

When the browser receives the read request issued from the web server, the browser feedbacks the network identity information of the user to the web server so that the web server enables to receive the network identity information.

In step 206, the web server match the network identity information with a local identity database to determine whether the local identity database stores one binding relationship between the network identity information and the server account information of the user of the web server. If the binding relationship exists in the local identity database, proceed to step 207, and if the binding relationship does not exist in the local identity database, proceed to step 208.

The local identity database is disposed in the web server for storing a plurality of binding relationships between the network identity information and server account information of the users in advance. In one embodiment, the server account information of the users includes account name and password thereof for the web server. In the beginning, the local identity database is initially empty and however, the binding relationships between the acquired network identity information and the account information of the user are increasingly accumulated while the different users continuously visit the web server. In one case, if the local identity database accumulates some network identity information and the account information mapping to the network identity information, the web server determines whether the acquired network identity information is found in can be found in the local identity database when the web server receives the acquired network identity information. That is, the web server checks whether the acquired network identity information is matched with the information in the local identity database.

In step 207, if the binding relationship exists in the local identity database, the web server queries the server account information stored in the local identity database based on the network identity information of the existing binding relationship.

When the web server successfully assures that the network identity information is matched with the local identity database to be found in the local identity database, the web server is able to query the account information corresponding to the acquired network identity information in the local identity database wherein the account information in the local identity database is mapped to the acquired network identity information.

In step 208, if the binding relationship does not exist in the local identity database, the web server demands the user to either register or login the web server.

If the web server cannot successfully match the acquired network identity information with the network identity information in the local identity database, the web server demands the user to either register or login the web server. For example, no binding relationship between the network identity information and server account information in the web server indicates two situations: (1) the user first visits the web server but does not register the web server by a new server account; and (2) although the user registers the web server by an existing server account, however, the web server does not make a binding relationship between the network identity information of the browser and server account information of the web server. Therefore, the web server demands the user to either register or login the web server due to the above-mentioned situations.

In step 209, the web server automatically logins the web server based on the server account information of the user.

After querying the account information corresponding to the acquired network identity information, the web server is capable of performing automatic login procedure since the account information originally belongs to the web server. It should be noted that the automatic login procedure in the web server is well-known in the art after querying the account information.

In step 210, the web server maps the server account information of the user to the network identity information and stores the mapping result in the local identity database after the user responds to the request of the web server.

After the user in the browser responds to the request of the web server by either registering or logging in the web server using a server account information, the web server maps the server account information of the user to the network identity information in the step 205 and stores the mapping result in the local identity database after the user responds to the request of the web server.

According to the above-mentioned descriptions, the method for providing a network service has many advantages as followings. The browser provides the account and password thereof for the user and generates the network identity information based on the account of the user. The web server maps the network identity information stored in the browser to the account information of the local identity database. Then, when the web server receives the network identity information from the browser again, the web server performs automatic login procedure. On one hand, the network identity information is continuously retained in the browser so that the web server performs automatic login procedure all the time, i.e. in a limitless time interval. On the other hand, if the user stores the network identity information in the browser and initially registers or login the web server when the user first visits the web servers, each of the web servers can perform automatic login procedures to prevent the user from memorizing the account information corresponding to a variety of web servers for increasing the user experience. The method of the present invention is used to register one account in each of web servers and perform automatic login procedure in each of web servers by using the browser.

### Third Embodiment

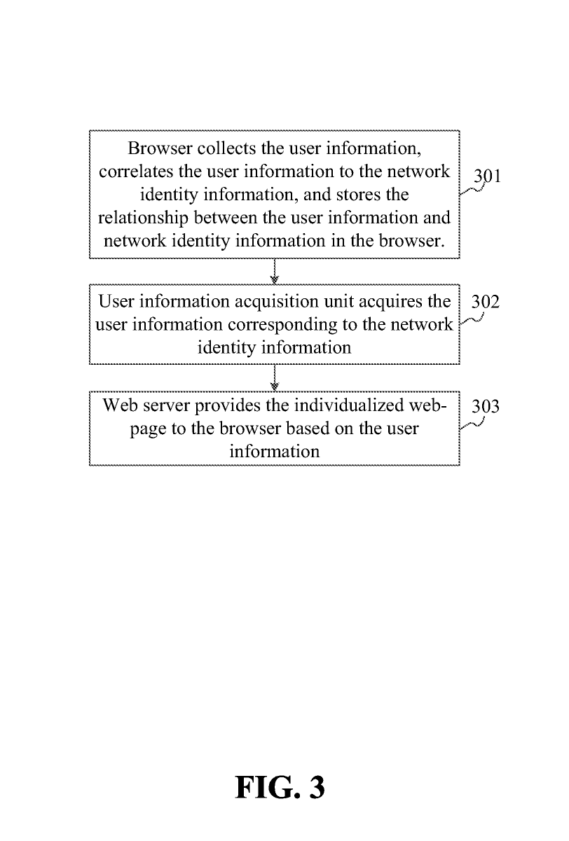

FIG. 3 is a flow chart of a method for providing network service according to the third embodiment of the present invention. The method for providing a network service in the third embodiment is applicable to a browser and a web server, which may be combined with the method in the second embodiment. The method includes the following steps.

In step 301, the browser collects the user information of the user, correlates the user information to the network identity information of the user, and stores the relationship between the user information and network identity information in the browser.

The browser collects the user information while the user either first registers a browser account in the browser or login the browser by an existing browser account. The user information is selected from one group consisting of the personal information corresponding to the network identity information and stored in the browser regarding the user, the apparatus operation information of the browser, the current network information and the combinations. In one embodiment, after the browser collects the user information of the user, the browser correlates the user information to the network identity information of the user and stores the relationship between the user information and network identity information. The personal information may be sex distinction, age, hobby, district information, contact information, education process and/or personal experience. The apparatus operation information may be brand, model number, display size, display resolution, and/or operation system (OS) platform of the apparatus. The current network information may be protocol and transmission velocity operated in the current network. That the browser collects the user information of the user can be performed by receiving and/or automatically acquiring the input information of the user.

In step 302, the user information acquisition unit 43 acquires the user information corresponding to the network identity information. The user information is selected from one group consisting of the personal information, the apparatus operation information of the browser, the current network information and the combinations.

When the network identity information is acquired or after the network identity information is acquired, the web server acquires the user information corresponding to the network identity information. Specifically, the web server issues the read request of the user information to the browser. When the user information includes at least two types, the web server may issue corresponding read requests of the user information based on all the types or partial types of the user information and thus, the browser feedbacks the corresponding user information to the web server based on the read requests of the user information.

In step 303, the web server provides the individualized web-page to the browser based on the user information.

Since the user information is selected from one group consisting of the personal information, the apparatus operation information of the browser, the current network information and the combinations, therefore, the web server can further process the received user information.

In one embodiment, when the web server acquires the personal information, the content of a web page is selected for feeding back to the user in the browser based on the personal information. That is, the web server utilizes the sex distinction, age, hobby, district information, contact information, education process and/or personal experience to integrate interesting web-page so as to feedback to the user. In one case, if the user's sex is female, his age is 20, and his hobby is entertainment, the web server provides the entertainment news or leisure games for the user.

In one embodiment, when the web server acquires the apparatus operation information of the browser, a format, a size and a resolution of the web page is selected for feeding back to the user in the browser based on the apparatus operation information of the browser. When the user browses the web page by the apparatus, the apparatus may be personal computer, cellular phone, tablet computer, electronic book and MP3. The browsers have different apparatus operation information including display size, display resolution, and/or operation system (OS) platform of the apparatus wherein the apparatus operation information is related to the display status of the web page. Therefore, when the web server acquires the apparatus operation information, a format, a size and a resolution of the web page is selected for feeding back to the user in the browser based on the apparatus operation information of the browser. Specifically, the web server selects the format of the web page based on the operation system (OS) platform of the apparatus, selects the size of the web page based on the display size, and selects the resolution of the web page based on the resolution of the apparatus.

In one embodiment, when the web server acquires the current network information, data volume of the web page is selected for feeding back to the user in the browser based on the current network information.

According to the above-mentioned descriptions, the apparatus for providing network service according to the fourth embodiment of the present invention acquires the user information corresponding to the network identity information so that web server selectively provides the individualized and suitable web-page to the user for improving the network browsing experience of the user.

### Fourth Embodiment

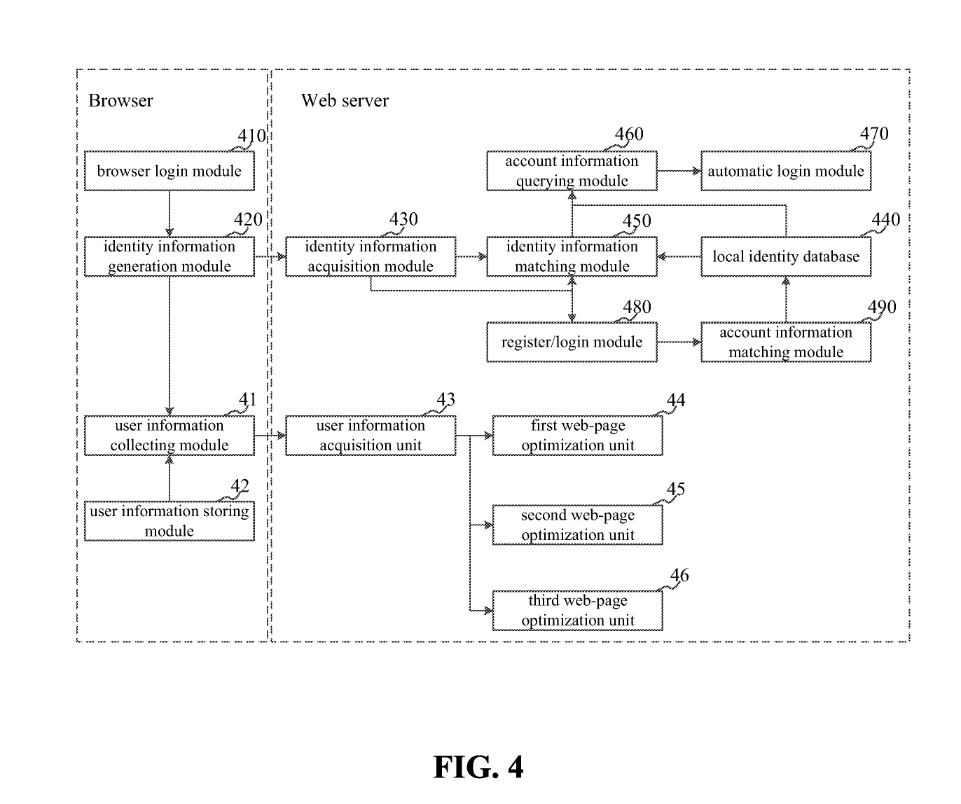

FIG. 4 is a schematic block diagram of an apparatus for providing network service according to the fourth embodiment of the present invention. The apparatus for providing network service includes a browser and a web server. The browser includes a browser login module 410 and an identity information generation module 420. The web server includes an identity information acquisition module 430, a local identity database 440, an identity information matching module 450, an account information querying module 460, an automatic login module 470, a register/login module 480 and account information matching module 490.

In the browser, the browser login module 410 collects the browser account information of the user. The identity information generation module 420 encrypts the browser account information from the browser login module 410 for generating the network identity information with unique recognition and storing the network identity information in the browser.

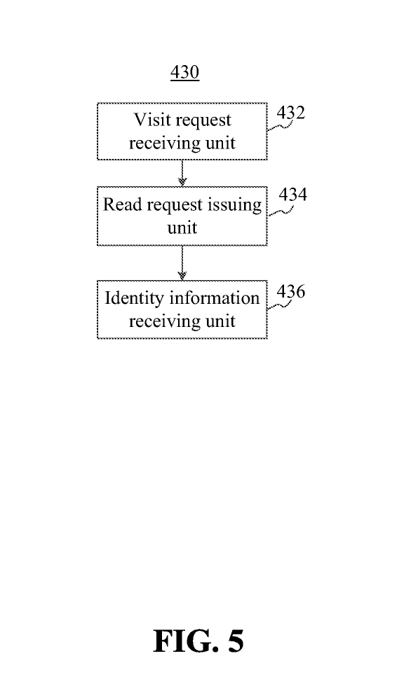

In the web server, the identity information acquisition module 430 acquires the network identity information of the user wherein the network identity information with unique recognition generated by the identity information generation module 420 is stored in the browser. As shown in FIG. 5, the identity information acquisition module 430 further includes a visit request receiving unit 432, a visit request receiving unit 434 and an identity information receiving unit 436. The visit request receiving unit 432 receives a visit request of the browser. The read request issuing unit 434 issues an identity information read request based on the visit request of the browser to the browser when the visit request receiving unit 432 receives the visit request. The identity information receiving unit 436 receives the network identity information which feedbacks from the browser after the browser responds the identity information read request issued by the read request issuing unit 434.

The local identity database 440 stores a binding relationship between the network identity information and the server account information of the user of the web server. In one embodiment, the server account information of the users includes account name and password thereof in the web server. In the beginning, the local identity database 440 is initially empty and however, the binding relationships between the acquired network identity information and the account information of the user are increasingly accumulated while the different users continuously visit the web server. During a predetermined span, the local identity database 440 accumulates some network identity information and the account information mapping to the network identity information.

The identity information matching module 450 matches the network identity information from the identity information acquisition module 430 with the local identity database 440. The account information querying module 460 queries the account information which is stored in the local identity database 440 based on the network identity information of the identity information acquisition module 430 if the identity information matching module 450 matches the network identity information with the local identity database 440 to be found in the local identity database 440. The automatic login module 470 automatically logs in the web server based on the server account information of the user from the account information querying module 460.

The register/login module 480 requests the user to either register or login the web server if the network identity information is not found in the local identity database. The account information matching module 490 maps the account information of the user to the network identity information from the identity information acquisition module 450 and stores the mapping result in the local identity database 440 after the user responds to the request of the register/login module 480.

According to the above-mentioned descriptions, the apparatus for providing a network service in the fourth embodiment stores the network identity information of the user in the browser beforehand so that the web server maps the network identity information stored in the browser to the account information of the local identity database. Then, when the web server receives the network identity information from the browser again, the web server performs automatic login procedure. On one hand, the network identity information is continuously retained in the browser so that the web server performs automatic login procedure all the time, i.e. in a limitless time interval. On the other hand, if the user stores the network identity information in the browser and initially registers or login the web server when the user first visits the web servers, each of the web servers can perform automatic login procedures to prevent the user from memorizing the account information corresponding to a variety of web servers for increasing the user experience. The method of the present invention is used to register one account in each of web servers and perform automatic login procedure in each of web servers by using the browser.

In one preferred embodiment, the browser further includes a user information collecting module 41 and a user information storing module 42. While the browser collects the user information while the user either first registers a browser account in the browser or login the browser by an existing browser account, the user information collecting module 41 collects the user information of the user. In one case, the user information is selected from one group consisting of the personal information, the apparatus operation information of the browser, the current network information and the combinations. The user information storing module 42 stores the collected user information from the user information collecting module and the corresponding network identity information of the user.

The web server further includes a user information acquisition unit 43, a first web-page optimization unit 44, a second web-page optimization unit 45 and a third web-page optimization unit 46. The user information acquisition unit 43 acquires the user information corresponding to the network identity information from the user information storing module 42. The user information is selected from one group consisting of the personal information corresponding to the network identity information to be stored in the browser, the apparatus operation information of the browser, the current network information and the combinations wherein the network identity information is from the identity information acquisition module 430. The first web-page optimization unit 44 selects the content of a web page for feeding back to the user in the browser based on the personal information acquired from the user information acquisition unit 43. The second web-page optimization unit 45 selects a format, a size and a resolution of the web page for feeding back to the user in the browser based on the apparatus operation information of the browser acquired from the user information acquisition unit 43. The third web-page optimization unit 46 selects data volume of the web page for feeding back to the user in the browser based on the current network information acquired from the user information acquisition unit 43.

According to the above-mentioned descriptions, the apparatus for providing network service according to the fourth embodiment of the present invention acquires the user information corresponding to the network identity information so that web server selectively provides the individualized and suitable web-page to the user for improving the network browsing experience of the user.

The apparatus for providing a network service in the fourth embodiment is capable of performing the methods for providing a network service in the second and third embodiments. Person skilled in the art should be noted that the apparatus and method for providing a network service in the above embodiments may be employed by hardware components. Further, the apparatus and method for providing a network service may be performed by procedures or programs which are stored in the computer readable media, such as read only memory (ROM), hard disk drive and optical disk.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for providing a network service, the method comprising the steps of:
collecting a browser account information of a user by a browser;
encrypting the browser account information of the user by the browser for generating a network identity information with an unique recognition and storing the network identity information in the browser;
acquiring the network identity information of the user from the browser by a web server;
matching the network identity information with a local identity database by the web server to determine whether the local identity database stores a binding relationship between the network identity information and a server account information of the user of the web server;
querying the server account information stored in the local identity database by the web server based on the network identity information of the binding relationship if the network identity information is matched with the local identity database to be found in the local identity database;
requesting the user to either register or login the web server if the network identity information is not found in the local identity database, and mapping the server account information of the user to the network identity information for storing the mapping result in the local identity database after the user responds to the request of the web server; and
automatically logging in the web server based on the server account information of the user.

2. A method for providing a network service, the method comprising the steps of:
acquiring a network identity information of a user wherein the network identity information with an unique recognition is stored in a browser;
matching the network identity information with a local identity database to determine whether the local identity database stores a binding relationship between the network identity information and an account information of the user;
querying the account information stored in the local identity database based on the network identity information of the binding relationship if the network identity information is matched with the local identity database to be found in the local identity database; and
automatically logging in the web server based on the account information of the user.

3. The method of claim 2, after the step of matching the network identity information with the local identity database, further comprising the steps of:
requesting the user to either register or login if the network identity information is not found in the local identity database; and
mapping the account information of the user to the network identity information for storing the mapping result in the local identity database after the user responds to the requesting step.

4. The method of claim 2, before the step of acquiring the network identity information of the user, further comprising the steps of:
collecting a browser account information of the user by the browser; and
encrypting the browser account information of the user by the browser for generating a network identity information with an unique recognition and storing the network identity information in the browser.

5. The method of claim 2, during the step of acquiring the network identity information of the user, further comprising the steps of:
receiving a visit request of the browser;
issuing a read request of the network identity information based on the visit request of the browser; and
receiving the network identity information which is a feedback from the browser after the browser responds to the read request of the network identity information.

6. The method of claim 2, further comprising the steps of:
acquiring a user information corresponding to the network identity information, wherein the user information is selected from one group consisting of a personal information corresponding to the network identity information and stored in the browser regarding the user, an apparatus operation information of the browser, a current network information and the combinations;
selecting a content of a web page for feeding back to the user in the browser based on the personal information if the personal information is acquired;
selecting a format, a size and a resolution of the web page for feeding back to the user in the browser based on the apparatus operation information of the browser if the apparatus operation information of the browser is acquired; and
selecting data volume of the web page for feeding back to the user in the browser based on the current network information if the current network information is acquired.

7. An apparatus for providing a network service applicable to a browser and a web server, the apparatus comprising:
a browser login module, for collecting a browser account information of a user;
an identity information generation module, for encrypting the browser account information of the user for generating a network identity information with an unique recognition and storing the network identity information in the browser;
an identity information acquisition module, for acquiring the network identity information of the user;
a local identity database, for storing a binding relationship between the network identity information and a server account information of the user of the web server;
an identity information matching module, for matching the network identity information from the identity information acquisition module with the local identity database;
an account information querying module, for querying the server account information stored in the local identity database based on the network identity information of the identity information acquisition module if the identity information matching module matches the network identity information with the local identity database to be found in the local identity database; and
an automatic login module, for automatically logging in the web server based on the server account information of the user.

8. The apparatus of claim 7, further comprising:
a register/login module, for requesting the user to either register or login the web server if the network identity information is not found in the local identity database; and
an account information matching module, for mapping the server account information of the user to the network identity information from the identity information acquisition module and for storing the mapping result in the local identity database after the user responds to the request of the register/login module.

9. The apparatus of claim 7, wherein the identity information acquisition module further comprises:
a visit request receiving unit, for receiving a visit request of the browser;
a read request issuing unit, for issuing an identity information read request based on the visit request of the browser to the browser; and
an identity information receiving unit, for receiving the network identity information which feedbacks from the browser after the browser responds the identity information read request.

10. The apparatus of claim 7, further comprising:
a user information acquisition unit, for acquiring a user information corresponding to the network identity information, wherein the user information is selected from one group consisting of a personal information corresponding to the network identity information to be stored in the browser by the user, an apparatus operation information of the browser, a current network information and the combinations;
a first web-page optimization unit, selecting a content of a web page for feeding back to the user in the browser based on the personal information acquired from the user information acquisition unit;
a second web-page optimization unit, selecting a format, a size and a resolution of the web page for feeding back to the user in the browser based on the apparatus operation information of the browser acquired from the user information acquisition unit; and
a third web-page optimization unit, selecting data volume of the web page for feeding back to the user in the browser based on the current network information acquired from the user information acquisition unit.

11. The apparatus of claim 7, further comprising:
a user information collecting module, for collecting a user information of the user, wherein the user information is selected from one group consisting of a personal information, an apparatus operation information of the browser, a current network information and the combinations; and
a user information storing module, for storing the collected user information from the user information collecting module and the corresponding network identity information of the user.

12. A web server, comprising:
an identity information acquisition module, for acquiring a network identity information of a user wherein the network identity information with an unique recognition is stored in a browser;
a local identity database, for storing a binding relationship between the network identity information and a server account information of the user of the web server;
an identity information matching module, for matching the network identity information from the identity information acquisition module with the local identity database;
an account information querying module, for querying the server account information which is stored in the local identity database based on the network identity information of the identity information acquisition module if the identity information matching module matches the network identity information with the local identity database to be found in the local identity database; and
an automatic login module, for automatically logging in the web server based on the server account information of the user.

13. The web server of claim 12, further comprising:
a register/login module, for requesting the user to either register or login the web server if the network identity information is not found in the local identity database; and
an account information matching module, for mapping the server account information of the user to the network identity information from the identity information acquisition module and for storing the mapping result in the local identity database after the user responds to the request of the register/login module.

14. The web server of claim 12, wherein the identity information acquisition module further comprises:
a visit request receiving unit, for receiving a visit request of the browser;
a read request issuing unit, for issuing an identity information read request based on the visit request of the browser; and
an identity information receiving unit, for receiving the network identity information which feedbacks from the browser after the browser responds the identity information read request.

15. The web server of claim 12, further comprising:
a user information acquisition unit, for acquiring a user information corresponding to the network identity information, wherein the user information is selected from one group consisting of a personal information corresponding to the network identity information to be stored in the browser by the user, an apparatus operation information of the browser, a current network information and the combinations;
a first web-page optimization unit, selecting a content of a web page for feeding back to the user in the browser based on the personal information acquired from the user information acquisition unit;
a second web-page optimization unit, selecting a format, a size and a resolution of the web page for feeding back to the user in the browser based on the apparatus operation information of the browser acquired from the user information acquisition unit; and
a third web-page optimization unit, selecting data volume of the web page for feeding back to the user in the browser based on the current network information acquired from the user information acquisition unit.

16. A browser, comprising:
a browser-registering module, for collecting a browser account information of a user; and
an identity information generation module, for encrypting the browser account information of the user for generating a network identity information with an unique recognition and storing the network identity information in the browser.

17. The browser of claim 16, further comprising:
a user information collecting module, for collecting a user information of the user, wherein the user information is selected from one group consisting of a personal information, an apparatus operation information of the browser, a current network information and the combinations; and
a user information storing module, for storing the collected user information from the user information collecting module and the corresponding network identity information of the user.
